(19) United States
(12) Patent Application Publication
(10) Pub. No.: US 2003/0107904 A1
(43) Pub. Date: Jun. 12, 2003

(54) Converter circuit arrangement for increasing an alternating voltage

(76) Inventors: Adrian Guggisberg, Station Siggenthal (CH); Jurgen Steinke, Albbruck (DE)

Correspondence Address: BURNS, DOANE, SWECKER & MATHIS, L.L.P., P.O. Box 1404, Alexandria, VA, 22313-1404, US

(21) Appl. No.: 10/307,287

(22) Filed: Dec. 2, 2002

(30) Foreign Application Priority Data
Dec. 10, 2001 (EP) 01811202.9

(51) Int. Cl. H02M 1/12

(52) U.S. Cl. 363/40; 323/247

(57) ABSTRACT

A converter circuit arrangement for increasing an alternating voltage is specified, which has a converter (2), which is designed as an inverter, a filter circuit (3) being connected to alternating voltage terminals (8.1, 8.2) of the converter (2) and the filter circuit (3) including at least one partial filter circuit (4). Furthermore, the partial filter circuit (4) is designed in such a way that a converter output current (I_{U}) flowing in the partial filter circuit (4) is leading in time with respect to a partial filter output voltage (U_{F}) present at load terminals (5, 6) of the partial filter circuit (4) and a converter output voltage (U_{U}) present at the alternating voltage terminals (8.1, 8.2) is limited to a specifiable value (|U_{Ub}|).

### TECHNICAL FIELD

The invention relates to the field of power electronics. It is based on a converter circuit arrangement for increasing an alternating voltage according to the precharacterizing clause of the independent claim.

### PRIOR ART

At the present time, there is an abundance of converter circuit arrangements, which are fed on the input side by a DC link circuit and supply a load on the output side. Such a converter circuit arrangement is given in EP 0 682 401 A1, for example. Here, the converter circuit arrangement has a converter designed as an inverter, which has a filter circuit on the output side and is designed as a three-phase unit. An electrical load to be supplied with an alternating voltage from the converter circuit arrangement can be connected to this filter circuit. With this filter circuit according to EP 0 682 401 A1, it is possible to limit the rate of change of the converter output voltage and thus the converter output voltage itself.

A problem with the converter circuit arrangement according to EP 0 682 401 A1 mentioned above is that the electrical load often requires a higher alternating voltage compared than converter output voltage, it not being possible, however, for either the converter or the filter circuit with its limiting effect to provide this increased alternating voltage at its output. Although it is generally well known that a transformer with an appropriate transformation ratio can be provided between the converter outputs and the filter circuit to increase an alternating voltage, such a transformer is, however, expensive, requires intensive maintenance, is subject to losses and requires a lot of space.

### BACKGROUND OF THE INVENTION

It is therefore the object of the invention to specify a converter circuit arrangement for increasing an alternating voltage, which enables an increased alternating voltage compared with an output voltage of a converter of the converter circuit arrangement to be produced in a particularly easy manner and which is designed simply and therefore cost-effectively. This object is achieved by the characteristics of claim 1. Advantageous improvements of the invention are given in the subclaims.

The converter circuit arrangement for increasing an alternating voltage according to the invention has a converter, which is designed as an inverter. Furthermore, a filter circuit is connected to alternating voltage terminals of the converter, which, according to the invention, includes at least one partial filter circuit, which is designed in such a way that a converter output current flowing in the partial filter circuit is leading in time with respect to a partial filter output voltage present at load terminals of the partial filter circuit and, in addition, a converter output voltage present at the alternating voltage terminals is limited to a specifiable value. As a result of the converter output current, which is set by the partial filter circuit and is leading in time with respect to the partial filter output voltage, and as a result of the converter output voltage, which is limited to a specifiable value by the partial filter circuit, advantageously, a partial filter output voltage is produced, which is an alternating voltage which is higher than the converter output voltage. By this means, an alternating voltage, in particular a converter output voltage, can be increased in a simple and particularly cost-effective manner, without additional circuits such as a transformer as disclosed by the prior art, for example, being necessary.

In a preferred embodiment of the converter circuit arrangement according to the invention, the partial filter circuit has a filter inductance and a filter capacitance, the filter capacitance being designed in such a way that the converter output current is leading in time with respect to the partial filter output voltage and the filter inductance limiting the converter output voltage to the specifiable value. By this means, a partial filter circuit of the converter circuit is achieved, which is particularly simple and made up of passive components and which requires no additional electrical energy supply of any kind to achieve the desired increase in partial filter output voltage or alternating voltage compared with the converter output voltage.

These and further objects, advantages and characteristics of the present invention will be apparent from the following detailed description of preferred exemplary embodiments of the invention in conjunction with the drawing.

### BRIEF DESCRIPTION OF THE DRAWINGS

In the drawing,

FIG. 1 shows a first embodiment of a converter circuit arrangement for increasing an alternating voltage according to the invention,

FIG. 2 shows a second embodiment of a converter circuit arrangement for increasing an alternating voltage according to the invention and

FIG. 3 shows a vector diagram of the relevant physical variables of the converter circuit arrangement according to the invention.

The references used in the drawing and their meaning are listed and summarized in the list of references. Basically, in the figures, the same parts are designated by the same references. The embodiments described are exemplary for the subject matter of the invention and do not have any limiting effect.

### WAYS OF IMPLEMENTING THE INVENTION

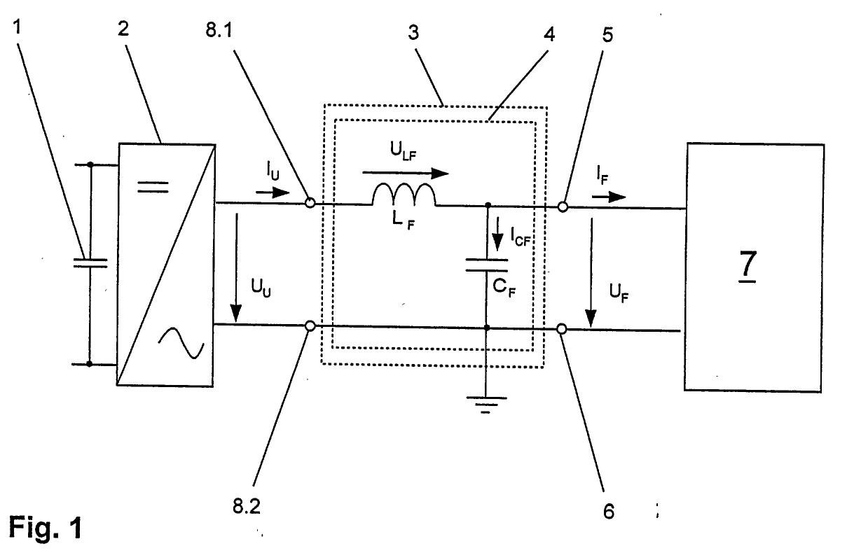

A first embodiment of a converter circuit arrangement for increasing an alternating voltage according to the invention is shown in FIG. 1. According to FIG. 1, the converter circuit arrangement has a converter 2, to the DC side of which a DC link circuit 1 is connected. The converter 2 is designed as an inverter and is equipped as a single-phase unit with a first alternating voltage terminal 8.1 and a second alternating voltage terminal 8.2. According to FIG. 1, a filter circuit 3 is connected to the alternating voltage terminals 8.1, 8.2.

According to the invention, in the single-phase converter 2 according to FIG. 1, the filter circuit 3 includes a single partial filter circuit 4, which has a first load terminal 5 and a second load terminal 6. According to the invention, the partial filter circuit 4 is designed in such a way that a converter output current I_{U} flowing in the partial filter circuit 4 is leading in time with respect to a partial filter output voltage U_{F} appearing at the load terminals 5, 6 of the partial filter circuit 4 and a converter output voltage U_{U} appearing at the alternating voltage terminals 8.1, 8.2 is limited to a specifiable value |U_{Ub}|. In the single-phase converter 2 according to FIG. 1, the converter output voltage U_{U} appears between the first alternating voltage terminal 8.1 and the second alternating voltage terminal 8.2. According to FIG. 1, the partial filter circuit 4 has a filter inductance L_{F} and a filter capacitance C_{F}, the filter capacitance C_{F} being designed in such a way that the converter output current I_{U} is leading in time with respect to the partial filter output voltage U_{F} and the filter inductance L_{F} limits the converter output voltage U_{U} to the specifiable value |U_{Ub}|. According to FIG. 1, the filter inductance L_{F} is connected to the first alternating voltage terminal 8.1 of the converter 2. The filter capacitance C_{F} is also connected to the second alternating voltage terminal 8.2 of the converter 2. Furthermore, the filter capacitance C_{F} is connected to the filter inductance L_{F}, the connecting point of the filter capacitance C_{F} to the filter inductance L_{F} forming the first load terminal 5 and the connecting point of the second alternating voltage terminal 8.2 to the filter capacitance C_{F} forming the second load terminal 6. Preferably, the connecting point of the second alternating voltage terminal 8.2 to the filter capacitance C_{F} is grounded, as a result of which voltages with respect to ground, i.e. so-called common mode voltages, are advantageously filtered.

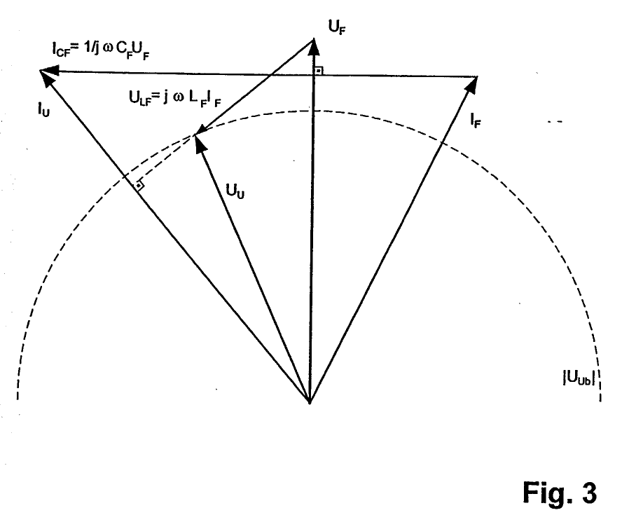

The relationships of the relevant physical variables, in particular of the voltages and currents of the converter circuit arrangement according to the invention, are shown in a vector diagram according to FIG. 3 for the embodiment of the converter circuit arrangement according to the invention shown in FIG. 1 and described above. The desired increased alternating voltage compared with the converter output voltage U_{U} appears on the two load terminals 5, 6 as the partial filter output voltage U_{F}, which is shown by the following explanation with reference to FIG. 3. According to FIG. 3, the partial filter circuit 4, due to its design, particularly of the filter capacitance C_{F}, adjusts the converter output current I_{U} flowing in the partial filter circuit 4 in such a way that the converter output current I_{U} is leading in time with respect to the partial filter output voltage U_{F}. According to FIG. 3, the converter output current I_{U} is given by the addition of a partial filter output current I_{F} and a filter capacitance current I_{CF} through the filter capacitance C_{F}, the partial filter output current I_{F} being determined by an electrical load 7 connected to the load terminals 5, 6. According to FIG. 3, the converter output voltage U_{U} is the sum of the partial filter output voltage U_{F} and a filter inductive voltage U_{LF} appearing across the filter inductance L_{F}, the filter inductance L_{F} effecting the limitation of the converter output voltage U_{U} to the specifiable value |U_{Ub}| described above. Preferably, the specifiable value |U_{Ub}| is the maximum permissible converter output voltage for which the converter 2 is designed, as a result of which, advantageously, the converter 2 does not have to be oversized with regard to its output voltage. The increased alternating voltage compared with the converter output voltage U_{U}, i.e. the partial filter output voltage U_{F}, is therefore produced, according to FIG. 3, by the adjustment of the converter output current I_{U} described above and by the limitation of the converter output voltage U_{U} described above.

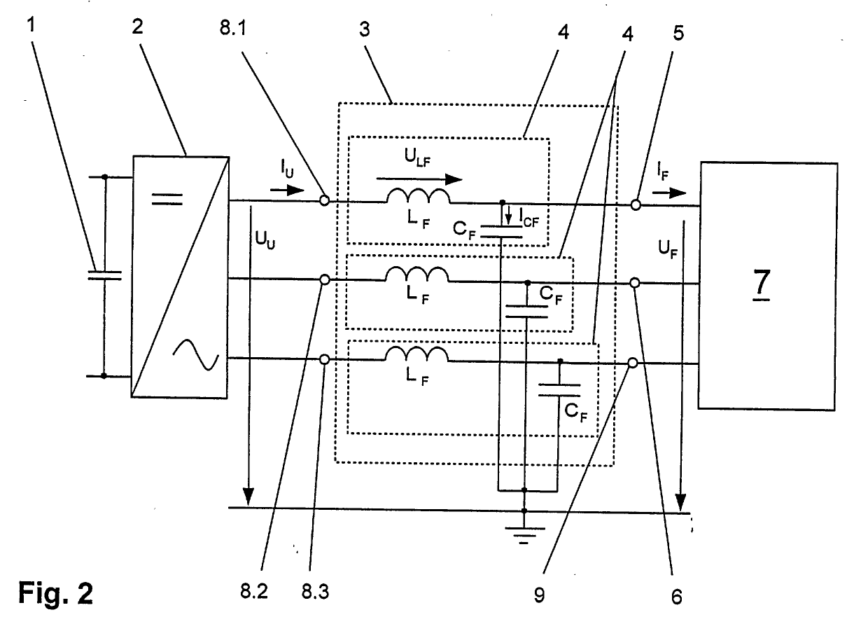

A second embodiment of a converter circuit arrangement according to the invention is shown in FIG. 2, which differs from the above-described first embodiment of the converter circuit arrangement according to the invention according to FIG. 1 to the effect that the converter 2 is designed to have n phases, i.e. is equipped with n alternating voltage terminals 8.1, 8.2, 8.3. Furthermore, the filter circuit 3 includes n partial filter circuits 4, a three-phase converter being shown as an example according to FIG. 2 and thus n=3, but, in the general case, n is ≧3. According to FIG. 2, a partial filter circuit 4 is connected to each alternating voltage terminal 8.1, 8.2, 8.3. Each partial filter circuit 4 according to FIG. 2 is the same partial filter circuit 4 as the partial filter circuit 4 described above in FIG. 1, i.e. each partial filter circuit 4 according to FIG. 2 has a filter inductance L_{F} and a filter capacitance C_{F}, the filter inductance L_{F} and the filter capacitance C_{F} being designed in accordance with the explanations of FIG. 1 described above so that the desired increased alternating voltage or partial filter output voltage U_{F} compared with the converter output voltage U_{U} is produced. According to FIG. 2, for each partial filter circuit 4, in accordance with the comments on the partial filter circuit 4 according to FIG. 1, the specifiable value |U_{Ub}| to which the converter output voltage U_{U} is limited, is advantageously the maximum permissible converter output voltage. The converter 2 is designed for this maximum permissible converter output voltage so that, advantageously, the converter 2 does not have to be oversized with regard to its output voltage. According to FIG. 2, the filter inductance L_{F} of the partial filter circuit 4 is connected to the appropriate alternating voltage terminal 8.1, 8.2, 8.3 and connected to the filter capacitance C_{F} of the associated partial filter circuit 4. According to FIG. 2, the connecting point of the filter inductance L_{F} to the filter capacitance C_{F} forms a load terminal 5, 6, 9, whereby, generally, with an n-phase converter 2, n load terminals 5, 6, 9 with n≧3 are provided. In addition, the filter capacitances C_{F} of the partial filter circuits 4 are connected together, the connecting point of the filter capacitances C_{F} preferably being grounded, as a result of which voltages with respect to ground, i.e. so-called common mode voltages, are advantageously filtered. In the n-phase converter 2 according to FIG. 2, a converter output voltage U_{U} appears at each alternating voltage terminal 8.1, 8.2, 8.3, which is referred to the potential of the grounded connecting point of the filter capacitances C_{F}, only the converter output voltage U_{U} for the alternating voltage terminal 8.1 and the further relevant physical variables for the partial filter circuit 4 connected to the alternating voltage terminal 8.1 being shown in FIG. 2 for the sake of clarity.

The relationships of the physical variables, in particular of the voltages and currents of the second embodiment of the converter circuit arrangement according to the invention according to FIG. 2 correspond to those of the comments made above with reference to the vector diagram according to FIG. 3 for the first embodiment of the converter circuit arrangement according to the invention according to FIG. 1.

The converter circuit according to the invention according to FIG. 1 and FIG. 2 is advantageously used in a connection to the electrical load 7 by means of a cable. In the connection, the electrical load 7 is connected to the cable, the converter circuit arrangement according to FIG. 1 and FIG. 2 described above being connected according to the invention to the cable by means of the load terminals 5, 6, 9 of the partial filter circuit 4. By this means, it is advantageously achieved that the voltage drop across the cable can be compensated for by the increased partial filter output voltage U_{F} so that the electrical load 7 can continue to be supplied to the required degree by an alternating voltage that is increased compared with the converter output voltage U_{U}.

Overall, by means of the converter circuit arrangement according to the invention, an alternating voltage, in particular a converter output voltage, can be increased in a simple and particularly cost-effective manner, without additional circuits and components being necessary.

List of References

1 DC link circuit

2 Converter

3 Filter circuit

4 Partial filter circuit

5 First load terminal

6 Second load terminal

7 Electrical load

8.1 First alternating voltage terminal

8.2 Second alternating voltage terminal

8.3 Third alternating voltage terminal

9 Third load terminal

1. A converter circuit arrangement for increasing an alternating voltage with a converter (2), which is designed as an inverter, a filter circuit (3) being connected to alternating voltage terminals (8.1, 8.2, 8.3) of the converter (2), characterized in that the filter circuit (3) includes at least one partial filter circuit (4) and in that the partial filter circuit (4) is designed in such a way that a converter output current (I_{U}) flowing in the partial filter circuit (4) is leading in time with respect to a partial filter output voltage (U_{F}) present at load terminals (5, 6, 9) of the partial filter circuit (4) and a converter output voltage (U_{U}) present at the alternating voltage terminals (8.1, 8.2, 8.3) is limited to a specifiable value (|U_{Ub}|).

2. The converter circuit arrangement as claimed in claim 1, characterized in that the partial filter circuit (4) has a filter inductance (L_{F}) and a filter capacitance (C_{F}), the filter capacitance (C_{F}) being designed in such a way that the converter output current (I_{U}) is leading in time with respect to the partial filter output voltage (U_{F}) and the filter inductance (L_{F}) limits the converter output voltage (U_{U}) to the specifiable value (|U_{Ub}|).

3. The converter circuit arrangement as claimed in claim 2, characterized in that the filter circuit (3) in a single-phase converter (2) includes a single partial filter circuit (4), the filter inductance (L_{F}) being connected to a first alternating voltage terminal (8.1) of the converter (2), a second alternating voltage terminal (8.2) of the converter (2) being connected to the filter capacitance (C_{F}), the filter capacitance (C_{F}) being connected to the filter inductance (L_{F}) and the connecting point of the filter capacitance (C_{F}) to the filter inductance (L_{F}) forming a first load terminal (5) and the connecting point of the second alternating voltage terminal (8.2) to the filter capacitance (C_{F}) forming a second load terminal (6).

4. The converter circuit arrangement as claimed in claim 3, characterized in that the connecting point of the second alternating voltage terminal (8.2) to the filter capacitance (C_{F}) is grounded.

5. The converter circuit arrangement as claimed in claim 2, characterized in that the filter circuit (3) in an n-phase converter (2) with n alternating voltage terminals (8.1, 8.2, 8.3) includes n partial filter circuits (4), n being ≧3, in that a partial filter circuit (4) is connected to each alternating voltage terminal (8.1, 8.2, 8.3) and in that the filter inductance (L_{F}) of the partial filter circuit (4) is connected to the appropriate alternating voltage terminal (8.1, 8.2, 8.3) and is connected to the filter capacitance (C_{F}) of the associated partial filter circuit (4), the connecting point of the filter inductance (L_{F}) to the filter capacitance (C_{F}) forming a load terminal (5, 6, 9) and the filter capacitances (C_{F}) of the partial filter circuits (4) being connected together.

6. The converter circuit arrangement as claimed in claim 5, characterized in that the connecting point of the filter capacitances (C_{F}) is grounded.

7. The converter circuit arrangement as claimed in one of the preceding claims, characterized in that the specifiable value |U_{Ub}| is the maximum permissible converter output voltage.

8. A connection to an electrical load (7) by means of a cable to which the electrical load (7) is connected, characterized in that the converter circuit arrangement as claimed in one of claims 1 to 7 is connected to the cable by means of the load terminals (5, 6, 9) of the partial filter circuit (4).
